(19) United States
(12) Patent Application Publication
(10) Pub. No.: US 2004/0246256 A1
(43) Pub. Date: Dec. 9, 2004

(54) Scalable vector graphics for SCADA functions

(76) Inventors: Jayapal Dharmapalan Parakkuth, Plymouth, MN (US); Krishna Vasudevan, Crystal, MN (US)

Correspondence Address: Siemens Corporation, Intellectual Property Department, 170 Wood Avenue South, Iselin, NJ, 08830, US

(21) Appl. No.: 10/839,301

(22) Filed: May 5, 2004

Related U.S. Application Data
(60) Provisional application No. 60/475,930, filed on Jun. 4, 2003.

(51) Int. Cl. G06T 1/00; G06F 15/00; G02B 15/02

(52) U.S. Cl. 345/501

(57) ABSTRACT

Certain exemplary embodiments comprise a method for monitoring an energy management system. The method can comprise providing a network-communicated SVG-formatted static representation of a schematic of an electrical power distribution system. The static representation can be rendered on a user interface. The method can comprise providing at least one measurable value related to an element of the electrical power distribution system. The at least one measurable value can be rendered on a user interface without refreshing the static representation.

### CROSS-REFERENCES TO RELATED APPLICATIONS

This application claims priority to, and incorporates by reference herein in its entirety pending U.S. Provisional Patent Application Ser. No. 60/475,930 (Attorney Docket No. 2003P08116US), filed 4 Jun. 2003.

### SUMMARY

Certain exemplary embodiments comprise a method for monitoring an energy management system. The method can comprise providing a network-communicated SVG-formatted static representation of a schematic of an electrical power distribution system. The static representation can be rendered on a user interface. The method can comprise providing at least one measurable value related to an element of the electrical power distribution system. The at least one measurable value can be rendered on a user interface without refreshing the static representation.

### BRIEF DESCRIPTION OF THE DRAWINGS

A wide variety of potential embodiments will be more readily understood through the following detailed description, with reference to the accompanying drawings in which:

FIG. 1 is a block diagram of an exemplary embodiment of a process management system 1000;

FIG. 2 is a block diagram of an exemplary embodiment of a user interface 2000;

FIG. 3 is a flow diagram of an exemplary embodiment of a method of monitoring a process 3000; and

FIG. 4 is a block diagram of an exemplary embodiment of an information device 4000.

### DEFINITIONS

When the following terms are used herein, the accompanying definitions apply:

alert—an electrical, electronic, or mechanical device and/or display that serves to advise of a condition by means of a sound or signal.

communication—an exchange of information.

current—a flow of electric charge.

data—distinct pieces of information, usually formatted in a special or predetermined way.

distribution—the process of supplying electrical power to users.

dynamic—time-varying.

electrical—relating to producing, distributing, and/or operating by electricity.

electrical power distribution system—an organized array of devices adaptable to transfer electricity from a first location to a second location.

electrical power flow rate—a quantifiable amount of electrical energy passing through a transmission line or device.

electrical power generation source—a facility and/or device adaptable to produce electricity.

electrical power transmission line—an electrically conductive medium adaptable to convey electrical energy from a first location to a second location.

element—a component. For example, an element of an electrical distribution system can be a generator, a power line, a transformer, a breaker, a fuse, and/or a switch, etc.

ethernet—a type of networking technology.

failure—a cessation of proper functioning or performance.

firmware—machine-readable instructions that are stored in a read-only memory (ROM). ROM's can comprise PROMs and EPROMs.

generation—the act or process of producing electrical power.

generator—a device adaptable to produce electrical power.

haptic—both the human sense of kinesthetic movement and the human sense of touch. Among the many potential haptic experiences are numerous sensations, body-positional differences in sensations, and time-based changes in sensations that are perceived at least partially in non-visual, non-audible, and non-olfactory manners, including the experiences of tactile touch (being touched), active touch, grasping, pressure, friction, traction, slip, stretch, force, torque, impact, puncture, vibration, motion, acceleration, jerk, pulse, orientation, limb position, gravity, texture, gap, recess, viscosity, pain, itch, moisture, temperature, thermal conductivity, and thermal capacity.

information—data.

information device—any device capable of processing information, such as any general purpose and/or special purpose computer, such as a personal computer, workstation, server, minicomputer, mainframe, supercomputer, computer terminal, laptop, wearable computer, and/or Personal Digital Assistant (PDA), mobile terminal, Bluetooth device, communicator, “smart” phone (such as a Handspring Treo-like device), messaging service (e.g., Blackberry) receiver, pager, facsimile, cellular telephone, a traditional telephone, telephonic device, a programmed microprocessor or microcontroller and/or peripheral integrated circuit elements, an ASIC or other integrated circuit, a hardware electronic logic circuit such as a discrete element circuit, and/or a programmable logic device such as a PLD, PLA, FPGA, or PAL, or the like, etc. In general any device on which resides a finite state machine capable of implementing at least a portion of a method, structure, and/or or graphical user interface described herein may be used as an information device. An information device can include well-known components such as one or more network interfaces, one or more processors, one or more memories containing instructions, and/or one or more input/output (I/O) devices, one or more user interfaces, etc.

input—a signal, data, and/or information provided to a processor.

Internet—a globally interconnected system of data networks.

I/O device—any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.

logical—a conceptual representation.

measurable—qualifiable and/or quantifiable.

memory device—any device capable of storing analog or digital information, for example, a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. The memory can be coupled to a processor and can store instructions adapted to be executed by the processor according to an embodiment disclosed herein. A memory device can comprise an archive and/or repository, such as a database.

network—a coupling of two or more information devices for sharing resources (such as printers or CD-ROMs), exchanging files, or allowing electronic communications therebetween. Information devices on a network can be physically and/or communicatively coupled via various wireline or wireless media, such as cables, telephone lines, power lines, optical fibers, radio waves, microwaves, ultra-wideband waves, light beams, etc.

network—communicated-provided via a network.

non-scrolling—a display of text and/or graphics visible without a user moving up, down, or across the display to see elements otherwise hidden from view.

process—an organized activity. Examples of a process comprise: materials conveying, materials pumping, materials manufacturing, heating systems, ventilating systems, air conditioning systems, chemical operations, mining, machining, packaging, and/or materials distribution, etc. A process can be monitored and/or controlled by a SCADA system.

processor—a hardware and/or software machine and/or virtual machine comprising a set of machine-readable instructions adaptable to perform a specific task. A processor comprises any one or combination of hardware, firmware, and/or software adaptable to perform a specific task. A processor acts upon information by manipulating, analyzing, modifying, converting, transmitting the information to an information device, and/or routing the information to an output device.

refresh—to update.

render—make perceptible to a human, for example as data, commands, text, graphics, audio, video, animation, and/or hyperlinks, etc., such as via any visual and/or audio means, such as via a display, a monitor, electric paper, an ocular implant, a speaker, a cochlear implant, etc.

responsive—reacting to an influence and/or impetus

SCADA—supervisory control and data acquisition.

scalable vector graphics (SVG)—a computer programming language for describing graphics and graphical applications. SVG can be adaptable to create and implement graphic images, animations, and interactive graphic designs for viewing via a network and/or the Internet. User interfaces adaptable to view SVG applications can comprise software supporting SVG technology. SVG can be adaptable to present scalable images. Graphics generated using SVG can be scalable making images larger or smaller without distorting them. Scalable graphics renderable using SVG can be adaptable to adjust graphic images, animations, and interactive graphic designs to an available window size and/or resolution.

schematic—a logical rendering of a system.

server—an information device and/or software that provides some service for other connected information devices via a network.

session—a period of time during which a user substantially continuously interacts with a software program.

static representation—a rendering that does not substantially change during a session.

status—information relating to a descriptive characteristic of a device and or system (e.g. on, off, in fault, etc.).

switch—a device used to close or open an electric circuit or to divert current from one conductor to another.

system component—any discrete element of an electrical power distribution system. A system component can be an electrical transformer, an electrical generator, and/or an electrical switch, etc.

SVG-rendered—made perceptible via SVG.

SVG-formatted—arranged for storage or display via SVG.

threshold—a point that when exceeded produces a given effect or result.

transformer—a device adaptable to transfer electric energy from one circuit to another. A transformer can comprise a pair of multiply wound, inductively coupled wire coils that effect such a transfer with a change in voltage, current, phase, and/or other electric characteristic.

updatable—adaptable to be provided with more current information.

user—any person, organization, process, device, program, protocol, and/or system that uses a device and/or service.

user interface—any device for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.

value—a definable quantity.

### DETAILED DESCRIPTION

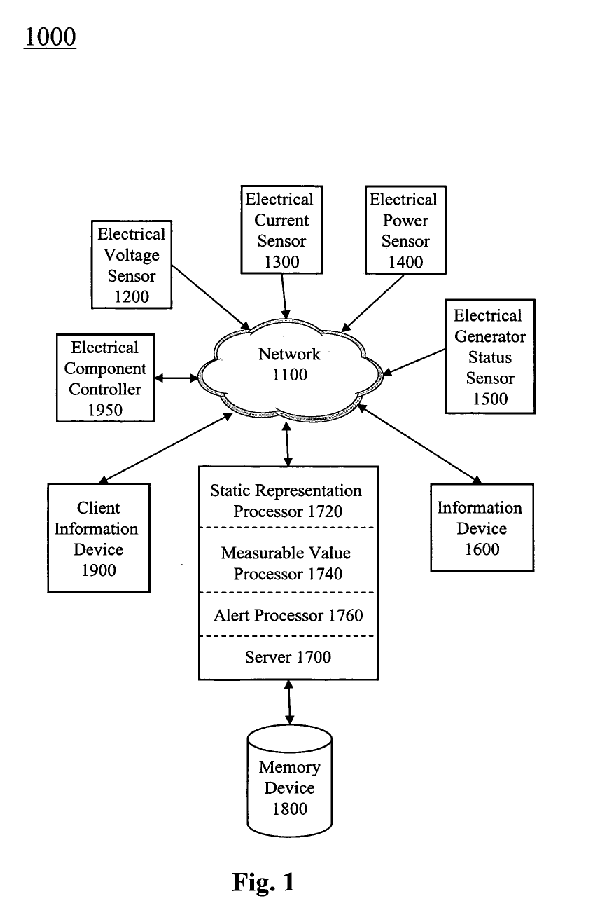

FIG. 1 is a block diagram of an exemplary embodiment of a process management system 1000, which in certain exemplary embodiments can comprise a network 1100. Network 1100 can be public, private, circuit-switched, packet-switched, virtual, radio, telephone, cellular, cable, DSL, satellite, microwave, AC power, twisted pair, ethernet, token ring, a LAN, a WAN, the Internet, an intranet, wireless, Wi-Fi, BlueTooth, Airport, 802.11a, 802.11b, 802.11g, etc., and/or any equivalents thereof. Certain exemplary embodiments comprise an industrial process. Certain exemplary embodiments comprise an energy management process. Certain exemplary embodiments comprise management processes for materials conveying, materials pumping, materials manufacturing, electrical power generation, heating systems, ventilating systems, air conditioning systems, chemical processing, mining, machining, packaging, and/or materials distribution, etc.

Network 1100 can be communicatively coupled to a plurality of process management system sensors such as an electrical voltage sensor 1200, an electrical current sensor 1300, an electrical power sensor 1400, and/or an electrical generator status sensor 1500. Energy management system sensors can provide dynamic information adaptable to be rendered via a user interface.

Network 1100 can be communicatively coupled to at least one controller such as an electrical component controller 1950. Electrical component controller 1950 can, for example, open or close a switch responsive to a directive from a user.

Network 1100 can be communicatively coupled to a server 1700. Server 1700 can receive a static representation of a process schematic, such as a one-line diagram for electrical generation and distribution. The process schematic and/or its static representation can be created using an information device, such as information device 1600, client information device 1900, and/or any other information device (not shown). The process schematic can be provided in SVG format and/or can be converted to a web page, such as an active server page (ASP), HTML page, etc. The information device can provide the process schematic to server 1700 and/or a memory, such as memory device 1800.

In certain exemplary embodiments, server 1700 can receive the static representation from an information device. In certain exemplary embodiments, server 1700 can receive the static representation from a memory, such as memory device 1800. The static representation can be network-communicated, SVG-renderable, and/or formatted as SVG, ASP, XML, HTML, etc. Rendering the static representation can allow the static representation to be displayed on a variety of physical and/or logical displays, such as a display coupled to server 1700, information device 1600, client information device 1900, and/or any number of other information devices (not shown). The variety of physical and/or logical displays can be of a plurality of sizes and/or resolutions. The rendered static representations and/or images can be viewed in a display without the user scrolling the image.

From a SCADA or other system, server 1700 can receive a measurable value of an element related to the process schematic, such as an element associated with electrical generation and/or distribution. In certain exemplary embodiments, server 1700 can receive information related to the element, such as descriptive information, predetermined threshold values, etc. In certain exemplary embodiments, server 1700 can receive the measurable value and/or element information at a frequency, time, etc. that is user-defined and/or predefined. In certain exemplary embodiments, server 1700 can receive the measurable value and/or element information from an information device, such as information device 1600; a memory, such as memory device 1800; from sensors, such as a SCADA-related sensor, electrical voltage sensor 1200, electrical current sensor 1300, electrical power sensor 1400, and/or electrical generator status sensor 1500. The measurable value and/or element information can be network-communicated, SVG-renderable, and/or formatted as SVG, ASP, XML, HTML, etc. Electrical voltage sensor 1200, electrical current sensor 1300, electrical power sensor 1400, electrical generator status sensor 1500 can respectively provide analog and/or digital information to server 1700.

Server 1700 can receive, determine, process, and/or provide an alert related to an element associated with the process schematic, such as an element associated with electrical generation and/or distribution. In certain exemplary embodiments, server 1700 (and/or another information device) can determine the alert based upon a predetermined threshold. The alert and/or predetermined threshold can be obtained from an information device, such as information device 1600, client information device 1900; and/or a memory, such as memory device 1800. The alert can be network-communicated, SVG-renderable, and/or formatted as SVG, ASP, XML, HTML, etc.

The process schematic, measured value, and/or information related to the process schematic and/or a related element can be obtained, for example, from a database formatted according to specifications of software created by the Oracle Corporation of Redwood Shores, Calif., and/or the Microsoft Corporation of Redmond, Wash.

Server 1700 and/or client information device 1900 can comprise a static representation processor 1720, a measurable value processor 1740, and/or an alert processor 1760. Static representation processor 1720 can receive information adaptable to be rendered as a network-communicated SVG-formatted static representation of a schematic of a process, such as an electrical distribution system.

Measurable value processor 1740 can receive a measured value and/or information related thereto, the measured value potentially associated with an element associated with the process schematic. Measurable value processor 1740 can be adaptable to render a display updatable at predetermined intervals responsive to changing process conditions. Measurable value processor 1740 can render the measurable value and/or information related thereto via a network-communicable SVG, formatted as SVG, ASP, XML, HTML, etc., and/or without refreshing the static representation.

Alert processor 1760 can receive information related to the measurable value exceeding a predetermined threshold. Alert processor 1760 can receive information related to a changing status of a component in the schematic. Alert processor 1760 can be adaptable to render alert information, the information updatable at predetermined intervals responsive to changing process conditions, such as a measurable value of an element related to the process schematic and/or function of measurable value of an element related to the process schematic exceeding a predetermined threshold and/or corresponding to a status of a component of the schematic. Alert processor 1760 can render the alert and/or information related thereto via network-communicable SVG, formatted as SVG, ASP, XML, HTML, etc., and/or without refreshing the static representation.

Access to displays coupled to information device 1600, server 1700, and/or information device 1900 can be restricted via a user-name and/or password. In certain exemplary embodiments, information device 1600, server 1700, and/or information device 1900 can comprise a Microsoft Internet Explorer Internet browser that can comprise one or more plug-ins, such as an SVG viewer plug-in.

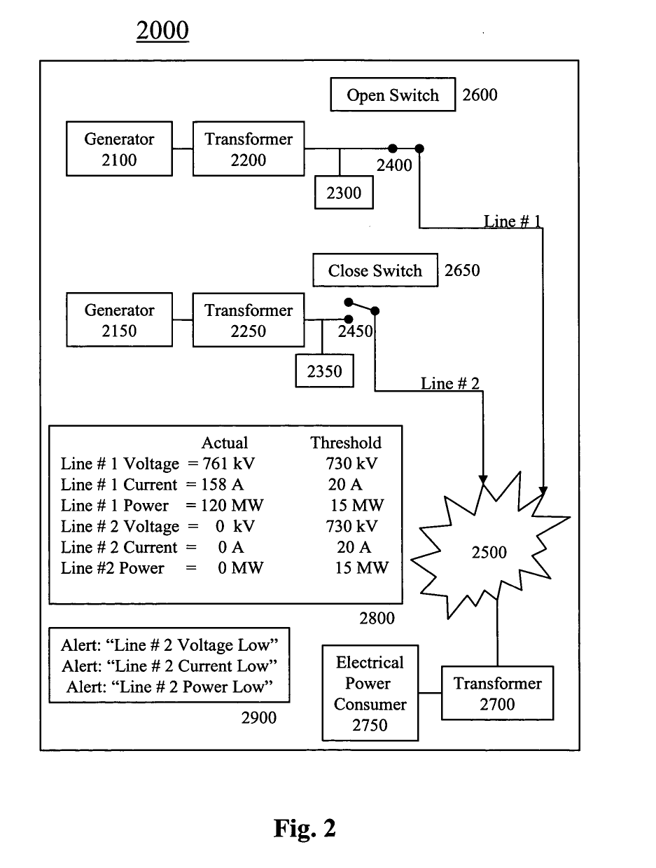

FIG. 2 is a block diagram of an exemplary embodiment of a user interface 2000 which in certain operative embodiments can comprise a static representation of a process schematic, such as for an industrial process, such as an electrical generation and/or distribution. In certain exemplary embodiments, the static representation can comprise representations such as: an electrical generator 2100, an electrical transformer 2200, an electrical sensor 2300, an electrical line #1, an electrical generator 2150, an electrical transformer 2250, an electrical sensor 2350, an electrical line #2, an electrical power transmission grid 2500, an electrical transformer 2700, and/or an electrical power consumer 2750. Electrical sensors 2300, 2350 can be adaptable to measure any value electrical value such as a voltage, a current, a power flow, and/or a power factor, etc. Electrical power transmission grid 2500 can comprise at least one electrical power transmission line and can comprise a plurality of transformers, fuses, and/or switches, etc. The static representation can be communicated via a network. The static representation can be provided and/or rendered via SVG. The static representation can be communicated via an ethernet network and/or the Internet.

User interface 2000 can comprise a measurable value of an element related to the process schematic, such as an element associated with an industrial process, such as an electrical generation and/or distribution system. In certain exemplary embodiments, the static representation can comprise representations such as an electrical switch 2400, an electrical switch 2450, and/or a sensor value display 2800. Sensor value display 2800 can display values obtainable from sensors such as electrical sensors 2300, 2350. Sensor value display 2800 can comprise a representation of values related to the electrical power distribution system such as a measured electrical voltage, electrical current, and/or power flow, etc. Sensor value display 2800 can also be adaptable to display at least one predetermined threshold for measurable values of elements related to the process schematic. The measurable value, such as Electrical switch 2400, electrical switch 2450, and/or sensor value display 2800, can be communicated via a network and/or can be rendered via SVG. The measurable value can be rendered without refreshing the static representation.

A measurable value of an element related to the process schematic exceeding the at least one predetermined threshold can result in an alert communication with a user. The user can receive an alert in an alert display 2900. Alert display 2900 can comprise notices corresponding to the at least one measurable value of an element related to the process schematic exceeding the predetermined threshold.

Alert display 2900 can comprise an alert corresponding to a status of a component of the schematic. Alert display 2900 can be dynamically updatable without refreshing the static representation. Alert display 2900 can be communicated via a network and/or rendered via SVG. Alert display 2900 can be dynamically updatable without refreshing the static representation.

In certain exemplary embodiments the static representation and/or elements of the static representation can be provided and/or rendered on a first virtual information layer of the user interface. The first virtual information layer can be provided to the user interface as a separate logical component of a process monitoring display.

The at least one measurable value can be provided and/or rendered on a second virtual information layer of the user interface. The second virtual information layer can be provided to the user interface as a separate logical component of a process monitoring display. The second virtual information layer can be adaptable to be updated at a predetermined interval responsive to changing conditions in the process.

The alert can be provided and/or rendered on the second and/or a third virtual information layer of the user interface. In certain exemplary embodiments, the alert can be provided to the user interface as a separate logical component of a process monitoring display. The alert can be adaptable to be updated at a predetermined interval responsive to changing conditions in the process.

In certain exemplary embodiments, user interface 2000 can comprise only one static element and/or virtual information layer. In certain exemplary embodiments, user interface 2000 can comprise a plurality of static elements and/or static virtual information layers. In certain exemplary embodiments, user interface 2000 can comprise only one dynamic element and/or virtual information layer. In certain exemplary embodiments, user interface 2000 can comprise a plurality of dynamic elements and/or dynamic virtual information layers.

User interface 2000 can comprise control elements such as, for example, an open switch selector 2600 and a close switch selector 2650. Open switch selector 2600 and close switch selector 2650 can be any user-activatable user interface element, such as radio buttons, hyperlinks, and/or active server page buttons, etc. Activation of open switch selector 2600 can result in the generation of a command to open an electrical switch associated with an electrical generation and/or distribution system. Activation of close switch selector 2650 can result in the generation of a command to close the electrical switch. In certain exemplary embodiments, control elements can also provide information adaptable to start up, operate, adjust, perturb, test, maintain, and/or shut down equipment associated with an industrial process, such as an electrical generation and/or distribution system.

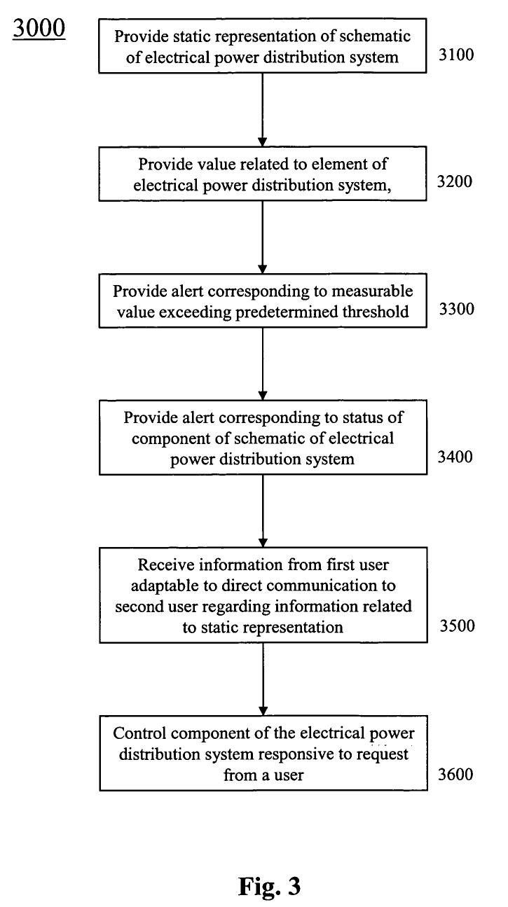

FIG. 3 is a flow diagram of an exemplary embodiment of a method of monitoring a process 3000. At activity 3100, certain exemplary embodiments can provide a static representation of a schematic diagram (e.g., one-line diagram, process flow diagram, etc.) of a process, such as for electrical power generation and/or distribution. The static representation can be adapted to be rendered via a user interface. The static representation can be network-communicated and/or formatted as SVG, ASP, XML, HTML, etc. The static representation can relate to any process and/or system, such as an electrical power generation system, an electrical power distribution system, a communication system, a manufacturing process, a laboratory process, etc.

At activity 3200, certain exemplary embodiments can provide a value related to an element of the process. The value can be dynamic, time-varying, measured, and/or measurable. The value can be adaptable to be rendered on a user interface. The value can be rendered and/or re-rendered via network-communicated SVG (and/or ASP, XML, HTML, etc.) without refreshing the static representation. The rendering of the value can be dynamically updatable via network-communicated SVG (and/or ASP, XML, HTML, etc.) without refreshing the static representation.

At activity 3300, certain exemplary embodiments can provide an alert corresponding to a measurable value of an element related to the process schematic exceeding a predetermined threshold. The alert can be related to an element of the process. The alert can be adaptable to be rendered on a user interface via network-communicable SVG (and/or ASP, XML, HTML, etc.). The rendering of the alert can be dynamically updatable via network-communicated SVG (and/or ASP, XML, HTML, etc.) without refreshing the static representation.

At activity 3400, certain exemplary embodiments can provide an alert corresponding to the status of a component of the schematic of the process. The alert can, for example, correspond to a generator shutting down, a generator starting up, a switch being opened, a switch being closed, a fuse failure, and/or a transformer failure, etc. The alert can be adaptable to be rendered on a user interface via network-communicable SVG (and/or ASP, XML, HTML, etc.). The rendering of the alert can be dynamically updatable via network-communicated SVG (and/or ASP, XML, HTML, etc.) without refreshing the static representation.

At activity 3500, certain exemplary embodiments can receive information from a first user adaptable to transmit a communication to a second user regarding information related to the static representation. For example, the first user can communicate an alert with the second user. The second user can take corrective action responsive to the alert. For example, the second user can replace and/or arrange to replace a fuse and/or a transformer. The second user can change a switch position and/or start or shut down an electrical power generator.

At activity 3600, certain exemplary embodiments can control a component of the process responsive to a request from a user. The component can be discretely controllable and/or variably controllable. For example, the user can provide information adaptable to change the position of an electrical switch, start up a process, start up equipment associated with a process, shut down a process, shut down equipment associated with a process, increase a flow rate, decrease a flow rate, increase a temperature, decrease a temperature and/or position a valve, etc.

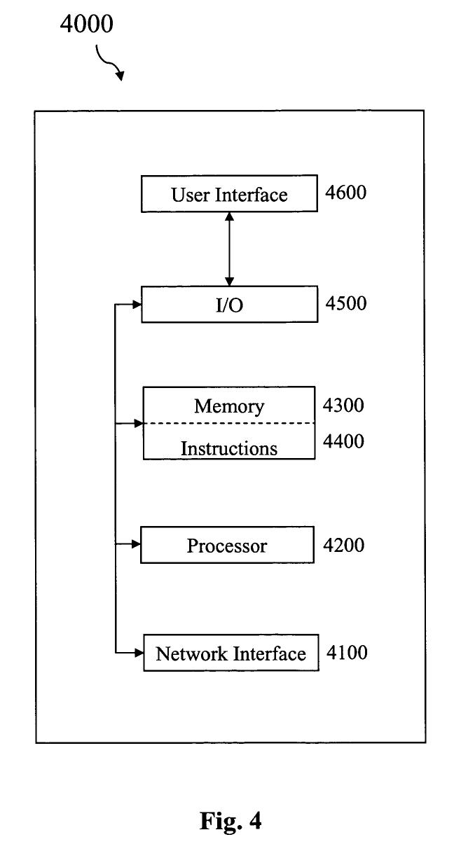

FIG. 4 is a block diagram of an exemplary embodiment of an information device 4000, which in certain operative embodiments can comprise, for example, information device 1700 and/or server 1600 of FIG. 1. Information device 4000 can comprise any of numerous well-known components, such as for example, one or more network interfaces 4100, one or more processors 4200, one or more memories 4300 containing instructions 4400, one or more input/output (I/O) devices 4500, and/or one or more user interfaces 4600 coupled to I/O device 4500, etc.

In certain exemplary embodiments, via one or more user interfaces 4600, such as a browser window, a user can view a schematic representation of a process. The user can view updatable process data in real time and/or receive alerts responsive to varying process conditions.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of the appended claims. For example, regardless of the content of any portion (e.g., title, field, background, summary, abstract, drawing figure, etc.) of this application, unless clearly specified to the contrary, there is no requirement for the inclusion in any claim of the application of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all subranges therein. Any information in any material (e.g., a U.S. patent, U.S. patent application, book, article, etc.) that has been incorporated by reference herein, is only incorporated by reference to the extent that no conflict exists between such information and the other statements and drawings set forth herein. In the event of such conflict, including a conflict that would render a claim invalid, then any such conflicting information in such incorporated by reference material is specifically not incorporated by reference herein.

What is claimed is:

1. A user interface comprising:
a network-communicated SVG-rendered static representation of a schematic of an electrical power distribution system; and
at least one measurable value related to an element of the electrical power distribution system, said at least one measurable value dynamically updatable without refreshing said static representation.

2. The user interface of claim 1, wherein said static representation is communicated via the Internet.

3. The user interface of claim 1, wherein said static representation is communicated via an ethernet network.

4. The user interface of claim 1, wherein said static representation is rendered on a first virtual information layer of said user interface, and said at least one measurable value is rendered on a second virtual information layer of the user interface.

5. The user interface of claim 1, further comprising:
an alert corresponding to said at least one measurable value exceeding a predetermined threshold, said alert dynamically updatable without refreshing said static representation.

6. The user interface of claim 1, further comprising:
an alert corresponding to said at least one measurable value exceeding a predetermined threshold, said alert renderable via SVG.

7. The user interface of claim 1, further comprising:
an alert corresponding to a status of a component of the schematic of the electrical power distribution system.

8. The user interface of claim 1, wherein said static representation comprises a representation of at least one electrical power transmission line related to the electrical power distribution system.

9. The user interface of claim 1, wherein said at least one measurable value comprises a representation of a measured electrical voltage related to the electrical power distribution system.

10. The user interface of claim 1, wherein said at least one measurable value comprises a representation of a measured electrical current related to the electrical power distribution system.

11. The user interface of claim 1, wherein said at least one measurable value comprises a representation of a measured electrical power flow rate related to the electrical power distribution system.

12. A system comprising:
a static representation processor adapted to render a network-communicated SVG-formatted static representation of a schematic of an electrical power distribution system; and
a measurable value processor adapted to render at least one measurable value related to an element of the electrical power distribution system, the at least one measurable value dynamically updatable via network-communicated SVG without refreshing the static representation.

13. The system of claim 12, further comprising:
an alert processor adapted to render at least one alert related to an element of the static representation, the at least one alert corresponding to a measurable value exceeding a predetermined threshold, the alert dynamically updatable without refreshing the static representation, wherein said alert processor is adaptable to render said at least one alert via SVG.

14. A method comprising:
providing a network-communicated SVG-formatted static representation of a schematic of an electrical power distribution system, said static representation adapted to be rendered on a user interface; and
providing at least one measurable value related to an element of the electrical power distribution system, said at least one measurable value adapted to be rendered on a user interface, the rendering of said at least one measurable value updatable via network-communicated SVG without refreshing said static representation.

15. The method of claim 14, further comprising:
providing an alert corresponding to the at least one measurable value exceeding a predetermined threshold, said alert adapted to be rendered on a user interface via SVG, the rendering of said alert dynamically updatable without refreshing said static representation.

16. The method of claim 14, further comprising:
receiving an instruction from a first user to transmit a communication to a second user regarding information related to said static representation.

17. The method of claim 14, further comprising:
changing an electrical switch position related to said static representation responsive to a request from a user.

18. The method of claim 14, further comprising:
controlling a component of the electrical power distribution system responsive to a request from a user.

19. A machine-readable medium storing instructions for activities comprising:
providing a network-communicated SVG-formatted static representation of a schematic of an electrical power distribution system, said static representation adapted to be rendered on a user interface; and
providing at least one measurable value related to an element of the electrical power distribution system, said at least one measurable value adapted to be rendered on said user interface, the rendering of said at least one measurable value updatable via network-communicated SVG without refreshing said static representation.

20. The machine-readable medium of claim 19, further comprising:
providing an alert corresponding to a measurable value exceeding a predetermined threshold, said alert adapted to be rendered on a user interface via SVG, the rendering of said alert dynamically updatable without refreshing said static representation.
